(19) United States
(12) Patent Application Publication
(10) Pub. No.: US 2020/0204414 A1
(43) Pub. Date: Jun. 25, 2020

(54) COMMUNICATION DEVICE AND METHOD FOR TRANSMITTING AND RECEIVING USING THE SAME

(71) Applicant: INDUSTRIAL TECHNOLOGY RESEARCH INSTITUTE, Hsinchu (TW)

(72) Inventors: Hung-Fu WEI, Hsinchu City (TW); Jing-Shiun LIN, Taichung City (TW); Chiu-Ping WU, Zhubei City (TW); Jen-Yuan HSU, Jincheng Township (TW)

(73) Assignee: INDUSTRIAL TECHNOLOGY RESEARCH INSTITUTE, Hsinchu (TW)

(21) Appl. No.: 16/225,895

(22) Filed: Dec. 19, 2018

(51) Int. Cl. H04L 27/26; H04L 5/00

(52) U.S. Cl. CPC H04L 27/2602; H04L 27/2649; H04L 27/2627; H04L 5/001

(57) ABSTRACT

A communication device and a transmitting and receiving method thereof. The communication device configured to transmit a first signal includes a code block (CB) segmentation unit, a plurality of first processing units, and a first resource mapping module. The CB segmentation unit is configured to divide at least one first transport block corresponding to the first signal into a plurality of first code blocks. Each of the first code blocks corresponds to one of the first processing units. The first processing units encode the first code blocks to obtain a plurality of first symbols. The resource mapping module performs resource mapping of the first symbols to obtain a first resource block.

### TECHNICAL FIELD

The disclosure relates in general to a communication device and a transmitting and receiving method thereof, and more particularly to a communication device equipped with multiple core processors and a transmitting and receiving method thereof.

### BACKGROUND

The recently developed communication technology of the 5-th generation (5G) mobile communication system mainly includes three features: enhanced mobile broadband (eMBB), massive machine type communication (mMTC), and ultra-reliable and low-latency communications (URLLC). The application fields, such as unmanned vehicle, remote medical surgery, tactile Internet, industrial automation manufacturing, or wireless control of manufacturing process, require low latency and high reliability, and have strict requirements regarding the reliability of data transmission and the latency between devices. However, the requirements of stated major developments would encompass shortening the processing time of baseband signals. During the processing of baseband signals, the channel coder/decoder normally consumes a large amount of operating time.

### SUMMARY

The disclosure is directed to a communication device and a transmitting and receiving method thereof. The communication device equipped with multiple core processors effectively uses each core processor and operating unit to determine the quantity of segmentations of the transport block (TB) for transmitting and receiving signals. The said transmitting and receiving of signals is also referred as signal transceiving.

According to one embodiment, a communication device is provided to transmit signals. The communication device includes a code block (CB) segmentation unit, a plurality of processing units, and a resource mapping module. The CB segmentation unit is configured to divide at least one transport block corresponding to the first signal into a plurality of code blocks. Each of the code blocks corresponds to one of the processing units. The processing units encode the code blocks to obtain a plurality of symbols. The resource mapping module performs resource mapping of the symbols to obtain a resource block.

According to another embodiment, a communication device is provided to receive signals. The communication device includes a resource mapping module, a plurality of processing units, and a code block (CB) aggregation unit. The resource mapping module performs resource mapping of the signal containing a resource block to obtain a plurality of symbols. The processing units decode the symbols to obtain a plurality of code blocks. Each of the symbols corresponds to one of the processing units. The CB aggregation unit is configured to aggregate the code blocks and output at least one transport block.

According to an alternative embodiment, a transmitting method of communication device is provided to transmit signals. The communication device includes a plurality of processing units, and the transmitting method includes the following steps. An operating resource unit instruction is sent by the processing units according to the quantity of processing units. The signal containing at least one transport block is divided into a plurality of code blocks. The code blocks are encoded to obtain a plurality of symbols. Resource mapping of the symbols is performed to obtain a resource block.

According to another alternative embodiment, a receiving method of communication device is provided to receive signals. The communication device includes a plurality of processing units, and the receiving method includes the following steps. An operating resource unit instruction is sent by the processing units according to the quantity of processing units. Resource mapping of a resource block of the signal is performed to obtain a plurality of symbols. The symbols are decoded to obtain a plurality of code blocks. The code blocks are aggregated and at least one transport block is outputted.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1 is a block diagram of a communication device.

FIG. 2 is a resource mapping diagram according to the communication device of FIG. 1.

FIG. 3A and FIG. 3B are partial block diagrams of the communication device of the present invention.

FIG. 4A and FIG. 4B are resource mapping diagrams of the communication device of FIG. 3A and FIG. 3B.

FIG. 5A is another resource mapping diagram of the communication device of FIG. 1.

FIG. 5B is a decoding timing diagram of FIG. 5A.

FIG. 6A is another resource mapping diagram of the communication device of FIG. 3A and FIG. 3B of the present invention.

FIG. 6B is a decoding timing diagram of FIG. 6A.

FIG. 7 is a block diagram of the transmitting and receiving process of the communication device of FIG. 3A and FIG. 3B of the present invention.

FIG. 8 is a partial block diagram according to another implementation of the communication device of the present invention.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

In the communication standard of the long term evolution (LTE) and the 5-th generation mobile communication system (5G), channel coding and channel decoding of the system are processed in units of code blocks (CB). A code block normally contains a large volume of bits to maintain system efficiency at a certain level. Along with the evolution of the semiconductor manufacturing process and the development trend of the communication device equipped with multiple core processors, it's foreseen that transmitting or receiving efficiency can be enhanced through the configuration of more processing units and the architecture of pipelined design or the use of more flash memories. Along with the improvement of hardware resource, the quantity of available core processors or core operating units also increases. Since the specification of using code blocks as units of processing rarely considers the quantity of available operating cores, the hardware design of communication device equipped with multiple core processors has limited improvement regarding latency. However, utilization of highly parallelism operation will effectively reduce latency.

In an embodiment of the present invention, the quantity of code blocks can be determined according to the quantity of available core processors. For example, when the communication device has a larger quantity of available core processors and is in a transmitting mode, the communication device can divide the transport block (TB) contained in the information bits into multiple independent code blocks according to the quantity of available core processors, and the code blocks are further encoded to obtain multiple code words (CW) and corresponding symbols. Here, channel coding is also referred as coding or encoding. The code blocks are parallelly coded by available core processors to generate multiple code words and corresponding symbols. The resource blocks obtained from the symbols by the resource mapping module are further modulated to output a baseband signal, such as a time domain baseband signal. When the communication device is in a receiving mode, the received baseband signal is demodulated. After the symbols and the corresponding code words are obtained by the resource mapping module, the code words are decoded by the available core processors. The code blocks obtained from parallel decoding performed by the core processors are aggregated and then the received information bits are outputted.

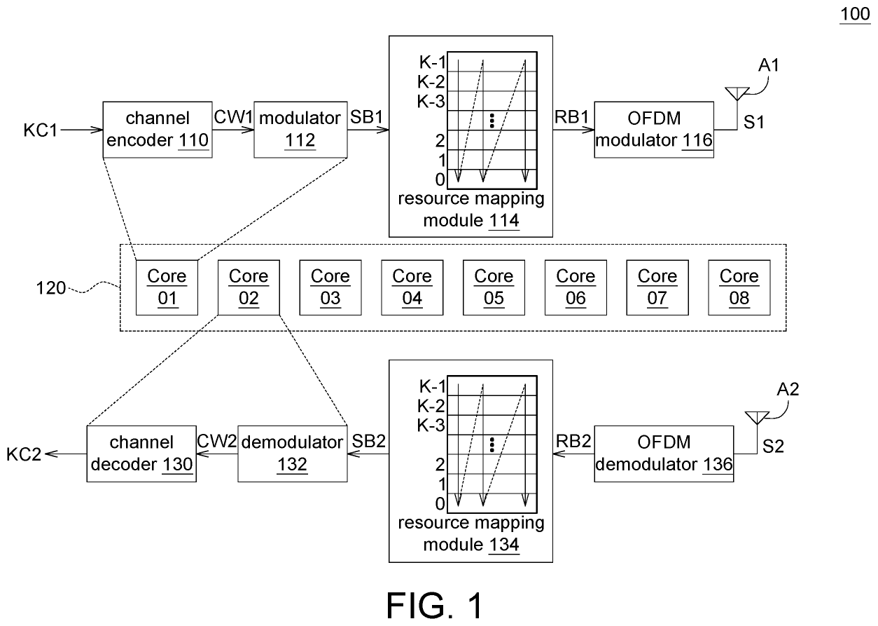

FIG. 1 is a block diagram of a communication device. The communication device 100 includes a core processor assembly 120 equipped with multiple core processors. Here, the core processor assembly 120 includes, for example, 8 core processors Core 01˜Core 08, which can be realized by core operating units such as central processing units (CPU), micro control units (MCU) or microprocessors. During the process of transmitting signals by the communication device 100, for example, the to-be-transmitted information includes an M1-bit information KC1, which is encoded by the channel coder 110 to obtain a code word CW1. Then, the code word CW1 is modulated by the modulator 112 to obtain a corresponding symbol(s) SB1. Then, the symbol(s) SB1 is allocated in a resource block RB1 formed by the resource mapping module 114. Then, the symbol(s) SB1 is modulated into a to-be-transmitted baseband signal S1 by the orthogonal frequency-division multiplexing (OFDM) modulator 116, and is transmitted by the antenna A1. Here, the baseband signal S1 is, for example, a time domain baseband signal. The channel coder 110 and the modulator 112 perform coding and modulation using, for example, the first core processor Core 01 of the core processor assembly 120.

Relatively, during the process of receiving signals by the communication device 100, the baseband signal S2 received by the antenna A2 is further demodulated by the OFDM demodulator 136 to generate a resource block RB2. Then, a symbol SB2 is obtained from the resource block RB2 by the resource mapping module 134, and is further demodulated by the demodulator 132 to obtain a corresponding code word CW2. The code word CW2 is decoded by the channel decoder 130 to obtain an M2-bit information KC2. Here, the demodulator 132 and the channel decoder 130 perform demodulation and decoding using, for example, the second core processor Core 02 of the core processor assembly 120.

In the communication device of FIG. 1, the processing time of the channel coder 110 and the processing time of the channel decoder 130 are positively proportional to the quantity of bits to be encoded or decoded, and during the transmitting or receiving process, the data required by the resource unit is encoded in units of code blocks. For example, the channel coder 110 and the channel decoder 130 use code blocks as units of processing, and each code block may have a large length, for example, 1K˜8K bits. The device equipped with multiple core processors or core operating units may have a larger quantity of idled core processors or core operating units and a larger amount resource waste.

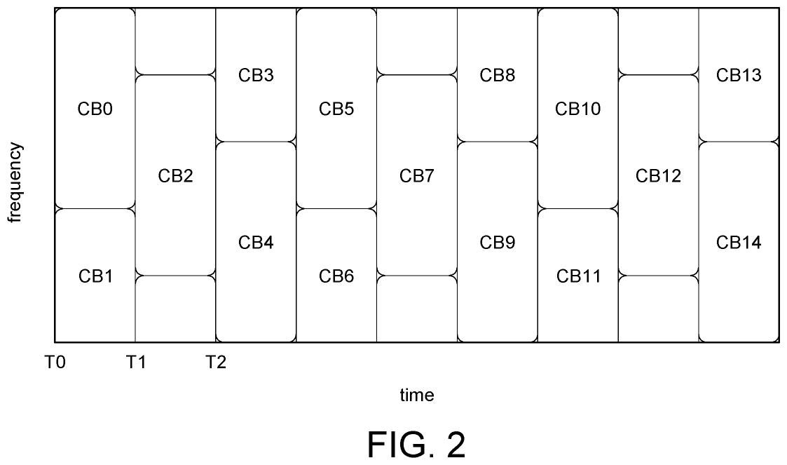

FIG. 2 is a resource mapping diagram according to the communication device of FIG. 1. As indicated in FIG. 2, each time the channel decoder 130 can only parallelly perform resource mapping in a small amount of code blocks, or even can hardly parallelly perform resource mapping of code blocks. For example, during an orthogonal frequency-division multiplexing (OFDM) symbol time period T0-T1, the channel decoder 130 can only perform resource mapping in the frequency domain of the symbols corresponding to the code block CB0 and a part of the symbols corresponding to the code block CB1. Since the resource mapping of the symbols corresponding to the code block CB1 is not completed, the encoding will not be completed until the next OFDM symbol time period T1-T2. As a result, the system has a longer waiting time, the majority of core processors are idled.

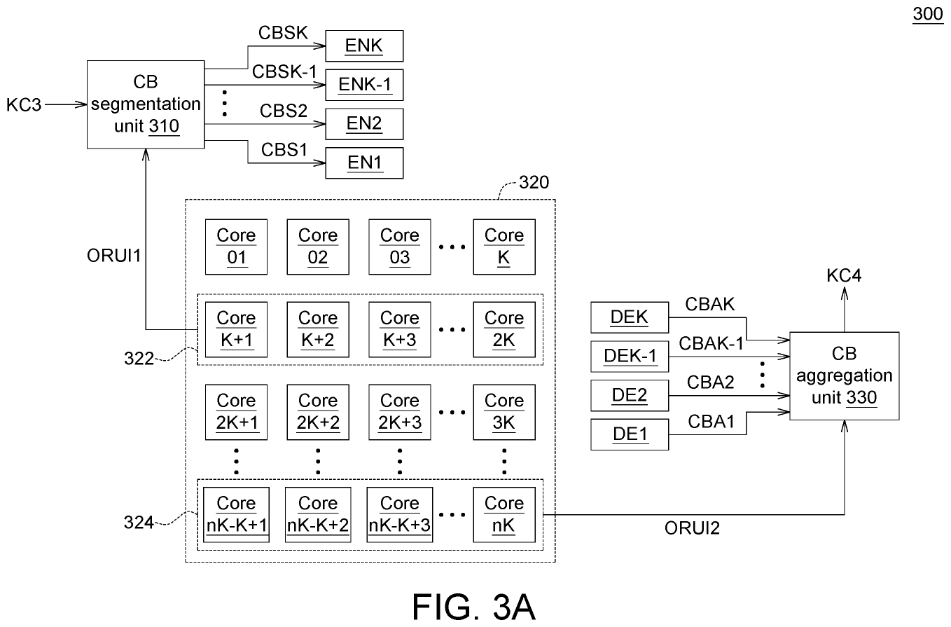

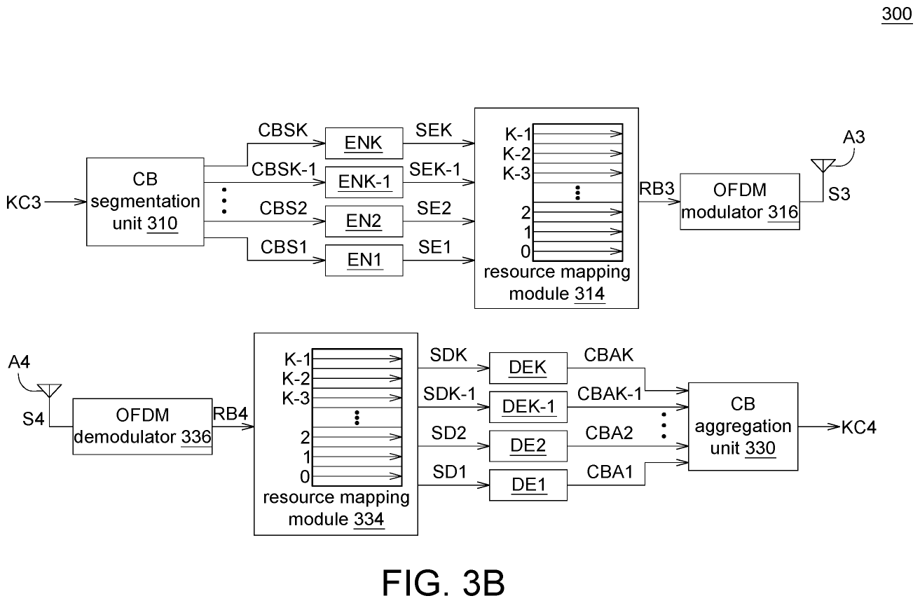

Referring to FIG. 3A and FIG. 3B, partial block diagrams of the communication device of the present invention are shown. The communication device 300 includes a core processor assembly 320 equipped with multiple core processors. The core processor assembly 320 includes n×K core processors Core 1˜Core nK, wherein, both n and K are integers greater than or equal to 1. When the core processor assembly 320 has K core processors available for channel coding or channel decoding, the communication device can perform parallel coding and decoding according to an operating resource unit instruction. For example, when the communication device 300 is in a transmitting mode and when a core operating group 322 with K core processors Core K+1˜Core 2K is available for channel coding, the core processor assembly 320 sends an operating resource unit instruction ORUI1. The CB segmentation unit 310, according to the operating resource unit instruction ORUI1, divides each to-be-transmitted transport block containing an M3-bit information KC3 into K code blocks CBS1˜CBSK, which have smaller length and/or are independent, and are respectively encoded by the channel coder EN1 of the core processor Core K+1, the channel coder EN2 of the core processor Core K+2, . . . , the channel coder ENK−1 of the core processor Core 2K−1, and the channel coder ENK of the core processor Core 2K. The code blocks are encoded to obtain multiple code words and K symbols SE1˜SEK corresponding to the code words. Then, the K symbols SE1˜SEK are allocated in the resource mapping module 314 and the resource mapping procedure is performed to obtain a resource block RB3. Then, the resource block RB3 is modulated by the OFDM modulator 316 to generate a baseband signal S3 which is to be transmitted. Then, the baseband signal S3 is transmitted by the antenna A3. Here, the baseband signal S3 is, for example, a time domain baseband signal. The K core processors Core K+1˜Core 2K may further include a modulator for modulating the code words into K symbols SE1˜SEK corresponding to the code words respectively.

Relatively, during the process of receiving signals by the communication device 300, the baseband signal S4 received by the antenna A4 is further demodulated by the OFDM demodulator 336 to generate a resource block RB4. When the core operating group 324 equipped with K core processors Core nK−K+1˜Core nK can be used for channel decoding, the core processor assembly 320 sends an operating resource unit instruction ORUI2. Here, channel decoding is also referred as decoding. Then, the resource mapping module 334 obtains K symbols SD1˜SDK and corresponding code words from the resource block RB4. The code words are parallelly decoded by the channel decoder DE1 of the core processor Core nK−K+1, the channel decoder DE2 of the core processor Core nK−K+2 . . . , the channel decoder DEK−1 of the core processor Core nK−1, and the channel decoder DEK of the core processor Core nK respectively to obtain K code blocks CBA1˜CBAK. Then, CB aggregation unit 330, according to the operating resource unit instruction ORUI2, aggregates the K code blocks CBA1˜CBAK to obtain a transport block containing an M4-bit information KC4. The antenna A3 and the antenna A4 of the communication device 300 can be the same antenna or can be two different and independent antennas. The baseband signal S3 transmitted via the antenna A3 will be transmitted to an another communication device (not illustrated). The antenna A4 receives the baseband signal S4 transmitted from the another communication device. In an embodiment, the baseband signal S3 is firstly converted into a radio frequency signal, which is then transmitted via the antenna A3. In an embodiment, the antenna A4 receives a radio frequency signal transmitted from an another communication device, and then converts the received radio frequency signal into a baseband signal S4.

The K core processor Core nK−K+1˜Core nK may further include a demodulator for demodulating the K symbols SD1˜SDK into multiple code words corresponding to the K symbols SD1˜SDK respectively. Additionally, after the received baseband signal S4 is demodulated by the OFDM demodulator 336, the demodulated baseband signal S4 is further processed by a decision feedback equalizer (DFE) to generate a resource block RB4, such that the error rate of the received baseband signal S4 can be reduced during the transmitting process.

In practical application, the hardware equipment of the system service provider can be more advanced than the hardware equipment at the user end. For example, the core processor assembly of the system service provider has more core processors than the core processor assembly at the user end. Moreover, the system service provider and the user end normally can perform both the transmitting function and the receiving function. Suppose that the system service provider is used as a signal transmitting end and the user end is used as a signal receiving end. When the system service provider transmits signals, the quantity of core processors for channel coding required by the system service provider can be determined according to an operating resource unit instruction ORUI1 sent from the core processor assembly 320 of the system service provider or according to the quantity of core processors for channel decoding replied from the user end. Thus, when the signal is transmitted after having been parallelly encoded and modulated by the system service provider, the receiving end will have the same quantity of core processors to parallelly demodulate and decode the received signal. Similarly, when the hardware resource at the transmitting end is different from that at the receiving end, the quantity of core processors at the transmitting end can be an integral times, for example, 2 times or 3 times, of that at the user end, and the signal can also be demodulated and decoded parallelly at the receiving end.

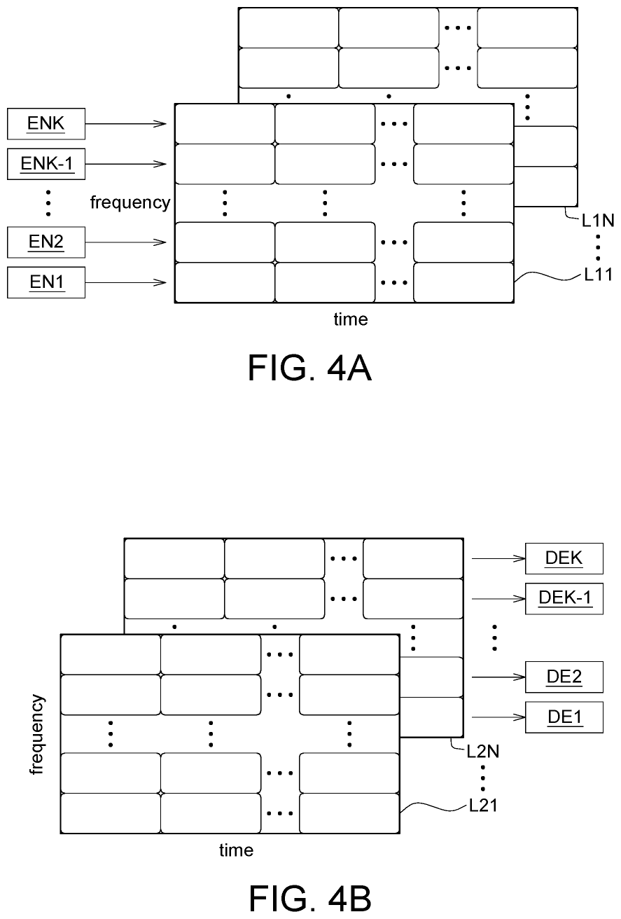

FIG. 4A and FIG. 4B are resource mapping diagrams according to the communication device of the invention. The communication device 300 can parallelly encode and decode the code blocks using multiple core processors. As shown in FIG. 4A, when the communication device 300 is in a transmitting mode, the code blocks are encoded by the channel coders EN1˜ENK to obtain multiple code words and K symbols SE1˜SEK corresponding to the code word. Then, resource mapping of the K symbols SE1˜SEK is performed by the resource mapping module 314 to obtain a layered resource mapping structure, for example, formed of N layers L11˜L1N. Thus, the symbols allocated in each layer also adopt parallel processing. Relatively, as indicated in FIG. 4B, when the communication device 300 is in a receiving mode, a layered resource mapping structure, for example, formed of N layers L21˜L2N is obtained from the resource block RB4, and the resource mapping module 334 performs resource mapping to obtain K symbols SD1˜SDK, which are parallelly decoded by the K channel decoders DE1˜DEK to obtain K code blocks CBA1˜CBAK.

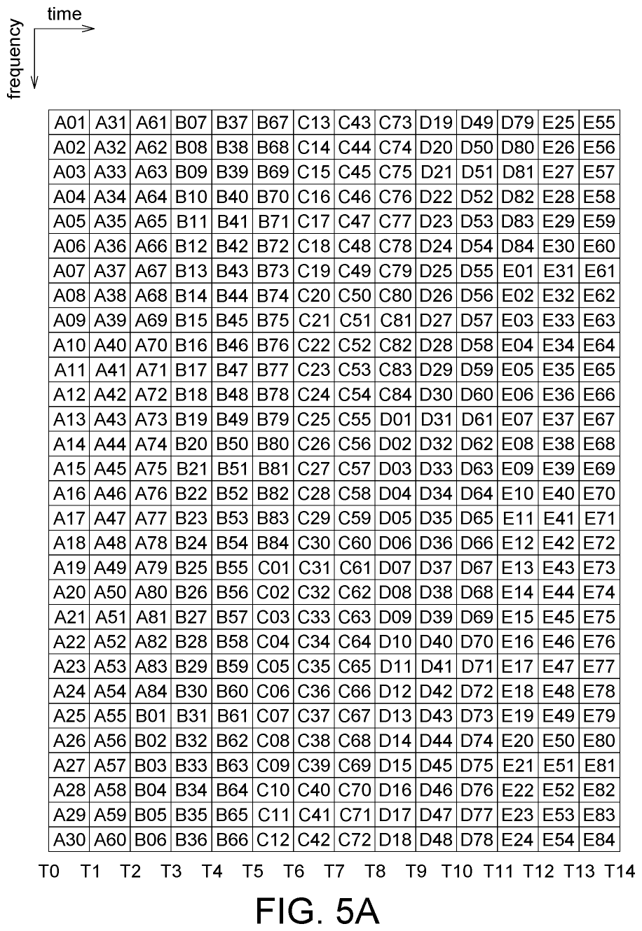

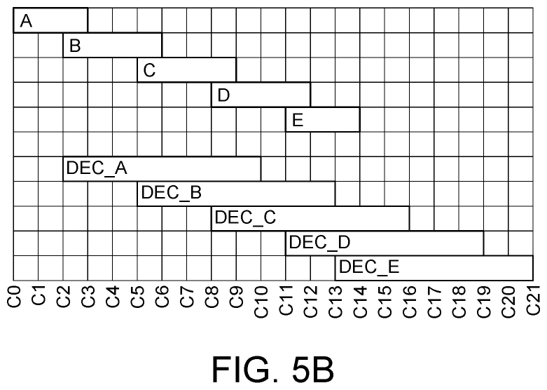

Refer to FIG. 5A and FIG. 5B. FIG. 5A and FIG. 5B respectively are a resource mapping diagram of the communication device of FIG. 1 and a decoding timing diagram of FIG. 5A. As indicated in FIG. 1, the resource mapping module 134 performs resource mapping of the resource block RB2 to obtain symbols SB2, which are further demodulated by the demodulator 132 to obtain a corresponding code word CW2. That is, the resource mapping performed by the resource mapping module 134 includes the to-be-obtained symbols SB2 and their corresponding code word CW2. In FIG. 5A, the resource mapping module 134 performs resource mapping in a resource mapping structure. For example, let the resource block RB2 include the to-be-obtained symbols A01˜A84, B01˜B84, C01˜C84, D01˜D84 and E01˜E84. The corresponding code word of the symbols A01˜A84 is A; the corresponding code word of the symbols B01˜B84 is B; the corresponding code word of the symbols C01˜C84 is C; the corresponding code word of the symbols D01˜D84 is D; the corresponding code word of the symbols E01˜E84 is E. As shown in FIG. 5A, resource mapping of the symbols is performed according to the frequency domain order and the time domain order sequentially to obtain a resource mapping structure. For example, at the first OFDM symbol time period T0-T1, symbols A01˜A30 are respectively allocated; at the second OFDM symbol time period T1-T2, symbols A31˜A60 are allocated; at the third OFDM symbol time period T2-T3, symbols A61˜A84 and B01˜B06 are allocated; at the fourth OFDM symbol time period T3-T4, symbols B07˜B36 are allocated; . . . until resource mapping of the symbols A01˜A84, B01˜B84, C01˜C84, D01˜D84 and E01˜E84 corresponding to the 5 code words A, B, C, D, and E is completed. As shown in FIG. 5A, in the present resource mapping structure, all of the symbols A01˜A84 corresponding to the code word A include 3 OFDM symbol time periods T0-T3 in total; all of the symbols B01˜B84 corresponding to the code word B include 4 OFDM symbol time periods T2-T6 in total; all of the symbols C01˜C84 corresponding to the code word C include 4 OFDM symbol time periods T5-T9 in total; all of the symbols D01˜D84 corresponding to the code word D include 4 OFDM symbol time periods T8-T12 in total; all of the symbols E01˜E84 corresponding to the code word E include 3 OFDM symbol time periods T11-T14 in total.

As shown in FIG. 5B, all of the symbols A01˜A84 corresponding to the code word A include 3 OFDM symbol time periods T0-T3 in total. Therefore, the time for obtaining all of the symbols A01˜A84 corresponding to the code word A includes 3 processing cycles C0˜C3. At the third processing cycle C2˜C3, the symbols B01˜B06 corresponding to the code word B can be received and obtained at the same time. Decoding starts at the third processing cycle C2˜C3 when some (or almost all) of the symbols corresponding to the code word A are obtained. In an embodiment, 8 (or more) processing cycles are required for completing the decoding of all of the symbols A01˜A84 corresponding to the code word A. For example, the processing cycle DEC_A for completing the decoding of all of the symbols A01˜A84 corresponding to the code word A includes 8 processing cycles C2˜C10. Similarly, the time for obtaining all of the symbols B01˜B84 of the code word B includes 4 processing cycles C2˜C6, and at the sixth processing cycle C5˜C6, the symbols C01˜C12 corresponding to the code word C can be obtained at the same time. Decoding starts at the sixth processing cycle C5˜C6 when some (or almost all) of the symbols corresponding to the code word B are obtained. The processing cycle DEC_B for completing the decoding of all of the symbols B01˜B84 corresponding to the code word B includes 8 processing cycles C5˜C13. The processing cycles required for obtaining and decoding all of the symbols corresponding to the code words C, D, and E are similar. In the present embodiment, 21 processing cycles C0˜C21 are required from the start of obtaining all of the symbols corresponding to the code word A till the end of decoding all of the symbols corresponding to the code word E.

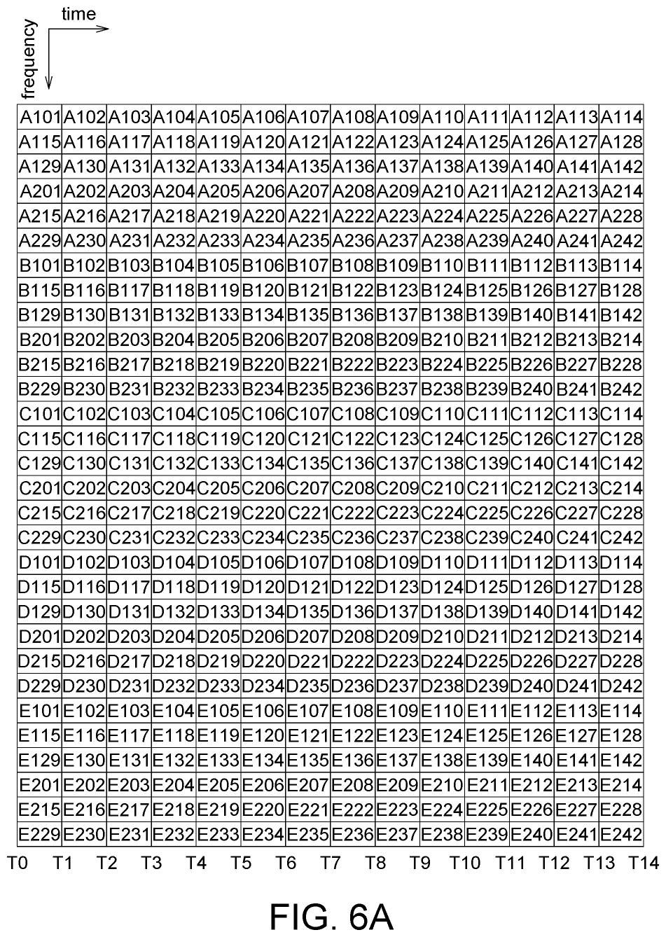

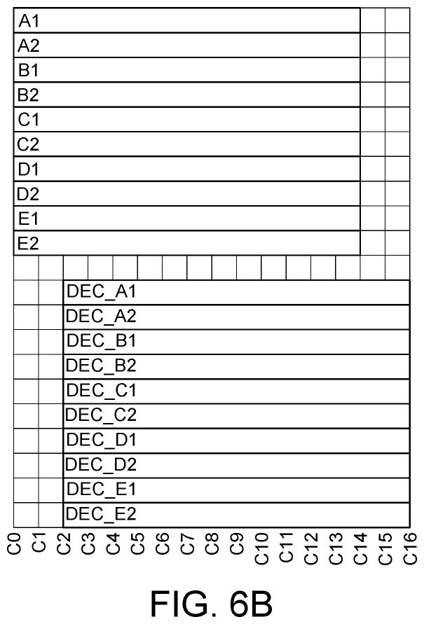

Refer to FIG. 6A and FIG. 6B. FIG. 6A and FIG. 6B respectively are a resource mapping diagram of the communication device of FIG. 3A and a decoding timing diagram of FIG. 3B. The resource mapping module 334 performs resource mapping of the resource block RB4 to obtain K symbols SD1˜SDK and their corresponding code word. That is, the resource mapping performed by the resource mapping module 334 includes the to-be-obtained K symbols SD1˜SDK and their corresponding code word. In FIG. 6A, the resource mapping module 334 performs resource mapping in a resource mapping structure. For example, let the resource block RB4 include the to-be-obtained symbols A101˜A142, A201˜A242, B101˜B142, B201˜B242, C101˜C142, C201˜C242, D101˜D142, D201˜D242, E101˜E142, and E201˜E242. The corresponding code word of the symbols A101˜A142 is A1; the corresponding code word of the A201˜A242 is A2; the corresponding code word of the symbols B101˜B142 is B1; the corresponding code word of the symbols B201˜B242 is B2; the corresponding code word of the symbols C101˜C142 is C1; the corresponding code word of the symbols C201˜C242 is C2; the corresponding code word of the symbols D101˜D142 is D1; the corresponding code word of the symbols D201˜D242 is D2; the corresponding code word of the symbols E101˜E142 is E1; the corresponding code word of the symbols E201˜E242 is E2. As indicated in FIG. 6A, resource mapping of the symbols is performed according to the time domain order first and then the frequency domain order sequentially to obtain a resource mapping structure. For example, at the first OFDM symbol time period T0-T1, symbols A101, A115, and A129, symbols A201, A215, and A229, symbols B101, B115, and B129, symbols B201, B215, and B229, symbols C101, C115, and C129, symbols C201, C215, and C229, symbols D101, D115, and D129, symbols D201, D215, and D229, symbols E101, E115, and E129, and symbols E201, E215, and E229 are respectively allocated; at the second OFDM symbol time period T1-T2, symbols A102, A116, A130; A202, A216, and A230, symbols B102, B116, and B130, symbols B202, B216, and B230, symbols C102, C116, and C130, symbols C202, C216, and C230, symbols D102, D116, and D130, symbols D202, D216, and D230, symbols E102, E116, and E130, and symbols E202, E216, and E230 are allocated; and the rest can be obtained by the same analogy until resource mapping of the symbols corresponding to the 10 code words A1, A2, B1, B2, C1, C2, D1, D2, E1, and E2 is completed. That is, all of the corresponding symbols of each of the code words A1, A2, B1, B2, C1, C2, D1, D2, E1, and E2 are allocated to the present resource mapping structure according to the time domain order first and then the frequency domain order sequentially. The corresponding symbols of each of the code words A1, A2, B1, B2, C1, C2, D1, D2, E1, and E2 are equally distributed over 14 OFDM symbol time periods T0-T14.

Then, as indicated in FIG. 6B, all of the corresponding symbols of each of the code words A1, A2, B1, B2, C1, C2, D1, D2, E1, and E2 include 14 OFDM symbol time periods T0-T14 in total. Therefore, the time for receiving and obtaining all of the corresponding symbols of each of the code words A1, A2, B1, B2, C1, C2, D1, D2, E1, and E2 includes 14 processing cycles C0˜C14, and at the third processing cycle C2˜C3, the corresponding symbols of each of the code words A1, A2, B1, B2, C1, C2, D1, D2, E1, and E2 can start to be parallelly decoded by multiple core processors (such as 10 core processors as exemplified in the present embodiment). If all of the corresponding symbols of each of the code words A1, A2, B1, B2, C1, C2, D1, D2, E1, and E2 are obtained at the 14-th processing cycle C13˜C14, the decoding of all of the corresponding symbols of each of the code words A1, A2, B1, B2, C1, C2, D1, D2, E1, and E2 will be parallelly completed at the 16-th processing cycle C15˜C16. For example, the processing cycle DEC_A1 for completing the decoding of all of the symbols A101˜A142 corresponding to the code word A1 includes 14 processing cycles C2˜C16, and the processing cycle DEC_E2 for completing all of the symbols E201˜E242 corresponding to the code word E2 also includes 14 processing cycles C2˜C16. That is, 16 processing cycles C0˜C16 are required from the start of obtaining all of the corresponding symbols of each of the code words A1, A2, B1, B2, C1, C2, D1, D2, E1, and E2 till the end of decoding all of the corresponding symbols of each of the code words A1, A2, B1, B2, C1, C2, D1, D2, E1, and E2.

As shown in FIG. 3A and FIG. 3B, since decoding is parallelly performed by multiple core processors in the present invention, the transport block corresponding to the received baseband signal S4 can be divided into independent code blocks having smaller length. FIG. 5A and FIG. 6A are illustrated with reference to the timing for performing resource mapping and decoding by individual communication devices in a receiving mode. As indicated in FIG. 5A and FIG. 6A, the baseband signal S2 received by the communication device 100 of FIG. 1 and the baseband signal S4 received by the communication device 300 of FIG. 3B have an identical quantity of symbols. However, the baseband signal S4 received by the communication device 300 includes more code words. For example, the communication device 100 includes 5 corresponding code words A, B, C, D, and E; the communication device 300 includes 10 corresponding code words A1, A2, B1, B2, C1, C2, D1, D2, E1, and E2, which are twice as much as that of the communication device 100. The quantity of code blocks CBA1˜CBAK obtained by the communication device 300 from the parallel decoding, which is performed by channel decoders DE1˜DEK, is also twice as much as the quantity of code blocks obtained by the communication device 100. Lastly, the information volume obtained by the communication device 300 from the transport block formed of K code blocks CBA1˜CBAK aggregated by the CB aggregation unit 330 is the same as the information volume obtained by the communication device 100. However, the communication device 300 of FIG. 3B performs parallel processing using multiple core processors, and the required processing time for resource mapping and decoding will be decreased to 16 processing cycles from 21 processing cycles.

The descriptions of FIGS. 5A and 5B and FIGS. 6A and 6B are exemplified by the quantity of code words and corresponding symbols contained in a single layer. In practical application, the code words and corresponding symbols can be adjusted according to the quantity of processors used in parallel decoding. Moreover, the descriptions of FIGS. 5A and 5B and FIGS. 6A and 6B are exemplified by the processing timing required for the communication device to perform resource mapping and decoding in the receiving mode. The processing timing required for the communication device to perform encoding and resource mapping in the transmitting mode is similar to that in the receiving mode, and the similarities are not repeated here.

The operating resource unit instruction effectively performs parallel processing using multiple core processors of the communication device. In practical application, the operating resource unit instruction can be graded according to the hardware capacity of the communication device. For example, factors such as the quantity of core processors of the communication device, memory space, and hardware resources occupied by other application programs also need to be considered. If the communication device has 8 core processors, 4 core processors could be used for channel coding or channel decoding, such that each core processor or operating unit can be effectively used.

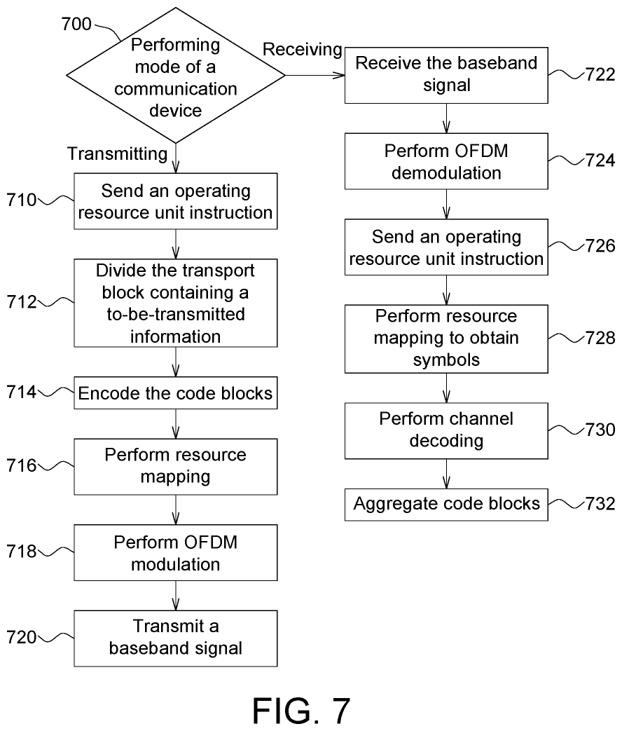

FIG. 7 is a block diagram of the transmitting and receiving process of the communication device of FIG. 3A and FIG. 3B of the present invention. Firstly, in step 700, determines whether the communication device 300 will perform a transmitting mode or a receiving mode. If the communication device 300 will perform the signal transmitting mode, then the process proceeds to step 710. If the communication device will perform the receiving mode, then the process proceeds to step 722. The communication device 300 may also perform the transmitting mode and the receiving mode at the same time. For example, when the communication device 300 transmits information KC3, as indicated in step 710, an operating resource unit instruction ORUI1 is sent according to the quantity of core processors available for the core processor assembly 320 to perform channel coding. Here, for example, the quantity of available core processors is K. Then, the process proceeds to step 712, according to the notice of the operating resource unit instruction ORUI1, each transport block containing the M3-bit information KC3 is divided into K independent code blocks CBS1˜CBSK having smaller length by the CB segmentation unit 310. Then, the process proceeds to step 714, each of the code blocks CBS1˜CBSK is encoded by the core processors Core K+1˜Core 2K to obtain a plurality of code words and K symbols SE1˜SEK corresponding to the code words. Then, the process proceeds to step 716, the symbols SE1˜SEK are allocated to the resource mapping module 314 and resource mapping is performed to obtain a resource block RB3. Then, the process proceeds to step 718, the resource block RB3 is modulated by the OFDM modulator 316 to generate a baseband signal S3 which is to be transmitted. Then, the process proceeds to step 720, the baseband signal S3, such as a time domain baseband signal, is transmitted by the antenna A3. In step 714, each of the code words may also be modulated to obtain K symbols SE1˜SEK corresponding to each of the code words.

Refer to FIG. 7. When the communication device 300 receives signals, as indicated in step 722, the baseband signal S4 is received by the antenna A4. Then, the process proceeds to step 724, OFDM demodulation of the baseband signal S4 is performed to generate a resource block RB4. Then, the process proceeds to step 726, an operating resource unit instruction ORUI2 is sent according to the quantity of core processors available for the core processor assembly 320 to perform channel decoding. Here, the quantity of available core processors is, for example, K. Then, the process proceeds to step 728, resource mapping of the resource block RB4 is performed by the resource mapping module 334 to obtain K symbols SD1˜SDK and the corresponding code words of each symbol. Then, the process proceeds to step 730, the code words are respectively and parallelly decoded by the core processors Core nK-K+1˜Core nK to obtain K code blocks CBA1˜CBAK. Lastly, the process proceeds to step 732, the code blocks CBA1˜CBAK are aggregated by the CB aggregation unit 330 to obtain a transport block containing an M4-bit information KC4 to complete the receiving of signals. In the step 728, the K symbols SD1˜SDK may also be demodulated into corresponding code words by the core processors Core nK-K+1˜Core nK. In the step 724, after OFDM demodulation of the baseband signal S4 is performed, the demodulated baseband signal S4 may further be processed by a decision feedback equalizer (DFE) to generate the resource block RB4.

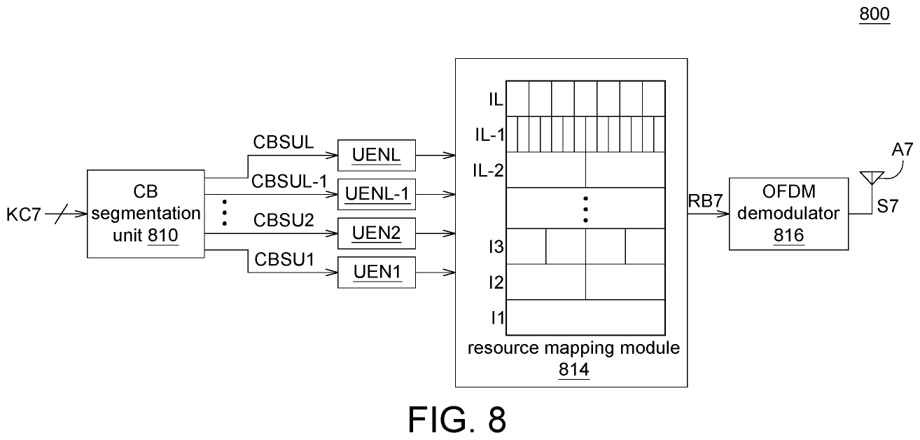

The communication device 300 of FIG. 3A and FIG. 3B is exemplified as a system service provider which communicates with one user end. In practical application, the technical features of the present invention may include the application of a system service provider which communicates with multiple user ends. FIG. 8 is a partial block diagram according to another implementation of the communication device of the present invention. The communication device 800 can be realized by a base station, a router or a sharer, each having multiple core processors. When multiple users need to transmit information to or receive information from the communication device 800, each user's information/code block can be independently encoded by the channel coder of a corresponding core processor, and the length of the corresponding code word of each user's code block can be different. The descriptions of the encoding operation disclosed above are applicable to the decoding operation. For example, the core processor includes a first core processor and a second core processor. The first user's information corresponds to the first transmitting code block. The second user's information of corresponds to the second transmitting code block. The first core processor encodes the first transmitting code block. The second core processor encodes the second transmitting code block. The length of the corresponding code word of the first transmitting code block is different from the corresponding code word of the second transmitting code block. For example, L users need to transmit an M7-bit information KC7 using the communication device 800, each user's to-be-transmitted information is divided into multiple independent code blocks having smaller length by the CB segmentation unit 810. Then, the first user's code block CBSU1 is encoded by the channel coder UEN1. The second user's code block CBSU2 is independently encoded by the channel coder UEN2. The rest can be obtained by the same analogy. The resource block RB7 formed in the resource mapping module 814 is modulated by the OFDM modulator 816 to generate a baseband signal S7 which is to be transmitted. The baseband signal S7 is then transmitted by the antenna A7. The encoding length of each user's to-be-transmitted information can be adjusted according to priority, such as the importance or the reliability of the information. That is, the length of the corresponding code words and/or symbols of each user's code block may vary with the priority. Therefore, each user's to-be-transmitted information can have different resource mapping parameters in the resource mapping module 814. For example, if the second user has lower priority than the third user, then the second user's resource mapping parameter 12 will be lower than the third user's resource mapping parameter 13. Meanwhile, the length of the code words and/or symbols corresponding to the second user's code block is longer. That is, when resource mapping of the second user's code block is performed by the resource mapping module 814, the OFDM symbol time period of each symbol is longer.

According to the present invention, the parallel operation of the communication device is adjusted according to the operating resource unit instruction. The to-be-encoded or to-be-decoded information, which is in units of transport block, is divided into multiple independent code blocks having smaller length, and the code blocks are further encoded or decoded by multiple core processors. When the quantity of core processors available for the communication device to perform parallel processing is considered, the information volume for channel coding or channel decoding is relatively reduced if more core processors are available. Meanwhile, given that the system efficiency of the communication device is maintained, the use of low-order modulation and encoding can effectively reduce the processing time of baseband signals. For example, the use of a lower coding rate and a lower modulation order not only maintains system efficiency, but also meets the requirement of having lower latency in the transmitting and receiving of signals.

To sum up, although the invention is disclosed in the prescribed embodiments, they do not mean to limit the invention. It will be apparent to those skilled in the art that various modifications and variations can be made to the spirit and context of the disclosed embodiments. Therefore, it is intended that a true scope of the invention being indicated by the following claims and their equivalents.

What is claimed is:

1. A communication device configured to transmit a first signal, the communication device comprising:
a code block (CB) segmentation unit configured to divide at least one first transport block corresponding to the first signal into a plurality of first code blocks;
a plurality of first processing units, wherein each of the first code blocks corresponds to one of the first processing units, and the first code blocks are encoded by the first processing units to obtain a plurality of first symbols; and
a first resource mapping module configured to perform resource mapping of the first symbols to obtain a first resource block.

2. The communication device according to claim 1, wherein the first resource mapping module performs resource mapping by layer according to the first symbols.

3. The communication device according to claim 1, wherein resource mapping of the first corresponding symbols of each of the first code blocks is performed according to a time domain order and then a frequency domain order sequentially to obtain the first resource block.

4. The communication device according to claim 1, wherein the first processing units comprise a first transmitting processing unit and a second transmitting processing unit; the first code blocks comprise a first transmitting code block and a second transmitting code block; the first transmitting processing unit encodes the first transmitting code block; the second transmitting processing unit encodes the second transmitting code block; and a length of the corresponding code word of the first transmitting code block is different from a length of the corresponding code word of the second transmitting code block.

5. The communication device according to claim 1, further comprising:
an orthogonal frequency-division multiplexing (OFDM) modulator configured to modulate the first resource block to obtain a baseband signal and transmit the baseband signal.

6. The communication device according to claim 1, wherein each of the processing units comprise:
a channel coding unit;
wherein, the first code blocks are parallelly encoded by the channel coding units to obtain a plurality of code words and the first symbols corresponding to the code words.

7. The communication device according to claim 6, wherein each of the processing units comprises:
a modulator configured to modulate the code words into the first symbols.

8. The communication device according to claim 1, wherein the first CB segmentation unit divides the first signal into the first code blocks according to a first operating resource unit instruction of the first processing units.

9. The communication device according to claim 1, further configured to receive at least one second signal, the communication device further comprising:
a second resource mapping module configured to perform resource mapping of a second resource block corresponding to the at least one second signal to obtain a plurality of second symbols;
a plurality of second processing units configured to decode the second symbols to obtain a plurality of second code blocks, and each of the second symbols corresponds to one of the second processing units; and
a code block (CB) aggregation unit configured to aggregate the second code blocks and output at least one second transport block.

10. The communication device according to claim 9, further comprising:
an orthogonal frequency-division multiplexing (OFDM) demodulator configured to demodulate the received at least one second signal to obtain the second resource block.

11. The communication device according to claim 9, wherein each of the second processing units comprises:
a channel decoding unit;
wherein the channel decoding units of the second processing units parallelly decode a plurality of second code words corresponding to the second symbols to obtain the second code blocks.

12. The communication device according to claim 11, wherein each of the second processing units comprises:
a demodulator;
wherein the demodulators of the second processing units demodulate the second symbols into the second code words.

13. The communication device according to claim 9, wherein the second resource mapping module obtains the second symbols according to a second operating resource unit instruction of the second processing units.

14. A transceiving method of a communication device for transmitting a first signal, wherein the communication device comprises a plurality of first processing units, the transceiving method comprising:
sending a first operating resource unit instruction by the first processing units according to a quantity of first processing units;
dividing at least one first transport block corresponding to the first signal into a plurality of first code blocks;
encoding the first code blocks to obtain a plurality of first symbols; and
performing resource mapping of the first symbols to obtain a first resource block.

15. The transceiving method according to claim 14, further comprising:
performing orthogonal frequency-division multiplexing (OFDM) modulation and transmitting the first resource block.

16. The transceiving method according to claim 14, wherein the step of encoding the first code blocks further comprises:
encoding the first code blocks to obtain a plurality of first code word; and
modulating the first code words to obtain the first symbols.

17. The transceiving method according to claim 14, further configured to receive at least one second signal, wherein when the communication device receives the at least one second signal, the method comprises the following steps:
sending a second operating resource unit instruction by the second processing units according to a quantity of second processing units;
performing resource mapping of a second resource block corresponding to the at least one second signal to obtain a plurality of second symbols;
decoding the second symbols to obtain a plurality of second code blocks; and
aggregating the second code blocks and outputting at least one second transport block.

18. The transceiving method according to claim 17, further comprising:
performing OFDM modulation on the received at least one second signal to obtain the second resource block.

19. The transceiving method according to claim 17, wherein the step of decoding the second symbols further comprises:
demodulating the second symbols into a plurality of second code words; and
decoding the code words to obtain the second code blocks.

20. A communication device configured to receive at least one signal, the communication device comprising:
a resource mapping module configured to perform resource mapping of a resource block corresponding to the at least one signal to obtain a plurality of symbols;
a plurality of processing units configured to decode the symbols to obtain a plurality of code blocks, wherein each of the symbols corresponds to one of the processing units; and
a code block (CB) aggregation unit configured to aggregate the code blocks and output at least one transport block.

21. The communication device according to claim 20, wherein the symbols have a layered resource mapping structure in the resource mapping module.

22. The communication device according to claim 20, wherein resource mapping of the symbols of the resource mapping structure is performed according to a time domain order and then a frequency domain order sequentially.

23. The communication device according to claim 20, further comprising:
an OFDM demodulator configured to demodulate the received at least one signal to obtain the resource block.

24. The communication device according to claim 20, further comprising:
a channel decoding unit;
wherein the channel decoding units of the processing units parallelly decode a plurality of second code words corresponding to the symbols to obtain the code blocks.

25. The communication device according to claim 24, further comprising:
a demodulator;
wherein the demodulators of the processing units demodulate the symbols into the code words.

26. The communication device according to claim 20, wherein the resource mapping module obtains the symbols according to an operating resource unit instruction of the processing units.

27. A receiving method of a communication device configured to receive at least one signal, wherein the communication device comprises a plurality of processing units, the receiving method comprising:
sending an operating resource unit instruction by the processing units according to a quantity of processing units;
performing resource mapping of a resource block corresponding to the at least one signal to obtain a plurality of symbols;
decoding the symbols to obtain a plurality of code blocks; and
aggregating the code blocks and outputting at least one transport block.

28. The receiving method according to claim 27, wherein when the communication device receives the at least one signal, the method further comprises:
performing OFDM demodulation on the received at least one signal to obtain the resource block.

29. The receiving method according to claim 27, wherein the step of decoding the symbols further comprises:
demodulating the symbols into a plurality of code words; and
decoding the code words to obtain the code blocks.
